(19) United States
(12) Patent Application Publication
(10) Pub. No.: US 2013/0133512 A1
(43) Pub. Date: May 30, 2013

(54) HYBRID CYLINDER

(71) Applicant: Peter A. Mueller, Gattikon (CH)

(72) Inventor: Peter A. Mueller, Gattikon (CH)

(21) Appl. No.: 13/642,781

(22) PCT Filed: Apr. 18, 2011
(86) PCT No.: PCT/CH11/00084

§ 371 Date: Feb. 7, 2013

(30) Foreign Application Priority Data
Apr. 21, 2010 (CH) 577/10

(51) Int. Cl. F15B 15/26; F15B 15/14

(52) U.S. Cl. CPC F15B 15/26; F15B 15/1457
USPC 92/110

(57) ABSTRACT

The invention relates to a hybrid working cylinder (1) which may be a hydraulic or pneumatic or electric working cylinder or rotary drive and a gas spring (8) assists the stroke (H) of a piston rod (5) in a power direction and, if required, a position of the stroke (H) can be blocked by means of a stroke locking mechanism (12) or a blocking valve (21) in the event of failure of the hybrid working cylinder (1) or of the working means, the gas spring (8) can move the entire system (25, 26) into a predetermined stroke position, and the gas spring (8) is attached, in the hybrid working cylinder (1) or outside the latter, to the axles (30) or between a platform (25) and the parallelogram (26). Furthermore, the gas spring cylinder (33) of the gas spring (8, 8a, 8b) may serve as a piston rod (5).

### TECHNICAL FIELD

The invention is based on a working cylinder that is electrically, hydraulically or pneumatically, meaning via normal compression air, combined with a gas spring; whereby, in swing applications, the output in one direction is increased by the factor of the output of the gas cylinder, and whereby, if necessary, the position can be locked by means of the gas spring according to the preamble of the first claim.

### PRIOR ART

Electrical working cylinders are known in the art, aside from hydraulic and pneumatic working cylinders, in which an electric motor drives a spindle that acts upon a spindle nut incorporated in the piston rod, wherein the piston rod is configured or held in such a way that the same is unable to turn, thereby transferring the rotary motion of the motor via the rotary motion of the spindle into a linear lifting motion. In different applications, furthermore, it is desirable for a stroke, once adjusted, to maintain said position even in the presence of a counterforce. Such lift locks are known in the art, in form of passive locks, such as, for example, irreversible spindle or worm gears, or by means of a sling spring and brake sleeve, as described in patent EP1 186 800 A1. Active locks are friction brakes that can be activated and deactivated, or displaceable toothed sleeves that are actuated by means of a fluid, as described in U.S. patent 2006/0207421. Electric, possibly hydraulic locking valves, are used in hydraulic systems.

Emergency running drives are mounted either on the motor or on the spindle; in the event of an electrical power failure, it is thus possible to adjust the cylinders and rotary drives manually, or, in the event for a hydraulic defect, by means of a manually acting pump.

Higher thrust forces are achieved in hydraulic and pneumatic drive systems by providing for an enlarged piston area or/and compression means; in electric drive systems this involves more complexity in that the thrust output can be increased by means of adjusting the spindle pitch or a larger electric motor.

### DESCRIPTION OF THE INVENTION

The object of the present invention is to provide a possible doubling of the installed output in a thrust direction by means of a gas spring, as well a cost-efficient locking mechanism of the stroke in the context of any lifting tasks, particularly with the use of an electrically operated working cylinder, however not exclusively.

A great percentage of industrial processing operations consists in shifting items from A to B in order to process, store or temporarily position the same. These activities require that a corresponding force is present on a force arm for moving an item, while during the return motion of the force arm, on the other hand, the corresponding force can often be extremely minimal for picking up a new item in the next cycle and only then providing full force once more. Small lifting mechanisms frequently use springs in order to return as quickly as possible to the starting point; larger systems utilize, for example, double-stroke fluid cylinders or electric cylinders that are configured for pressure and tension, and which return a corresponding force arm to the ready position thereof for carrying out a new task.

Presently mentioned by way of an example is the lifting and lowering of items where gravity demonstrates a significant working difference relative to the force that must be applied for swinging upward or downward, respectively. A force is applied in most cases during the lifting action in order to lift a weight of an item over time; however, when lowering the swing arm, this means in most instances that weight must be decelerated, even if this is only the dead weight of the swing arm. Only recently has deceleration energy increasingly come to be stored in form of energy recycling in order to be released once again when needed, which has been made possible, first and foremost, due to the availability of cheaper electronic controls and storage technologies.

Aside from optimizing energy management, the physical size of a lift means must also be considered as a relevant criteria, as well as security and the redundant emergency position. Consequently, an application of this kind cannot be calculated based on the energy budget alone.

The advantage of hydraulically and pneumatically operated systems lies in the fact that a new system construction is not absolutely necessary in order to double the thrust force; in fact, a doubling of the thrust force can be achieved by, for example, doubling the pressure inside the cylinders. However, this is not so easily achieved in an electric cylinder or an electric swivel motor. Instead, a correspondingly, newly dimensioned electric motor and a correspondingly dimensioned and possibly newly calculated spindle pitch are necessary, which means a completely new cylinder. The complexity that is involved with such an electric cylinder is disproportionately greater than with a fluid cylinder resulting, at any rate, in a substantially larger cylinder in terms of the construction thereof.

The invention uses a gas spring therein as a supporting element for achieving a thrust increase without having to modify the overall mechanics of the electric cylinder, wherein such a gas spring is integrated, on the one hand, by way of a space-saving measure as a parallel means on a working cylinder, irrespective as to whether the same is operated hydraulically, pneumatically or electrically; and the gas spring is integrated directly in an electric cylinder, on the other hand, due dirt particles. Furthermore, the gas spring can fulfill an emergency function; specifically, if the system fails, for example, the rocking lever is safely moved to the upper or lower position thereof, and it remains in this homing position until the malfunction has been repaired. In addition, the gas spring can be used as a locking means in the blockable configuration, such that a rocking lever can be held in a position once the same has been reached—even with open hydraulic or pneumatic magnetic valves, or brakeless and non-self-locking spindle in an electric cylinder—and the position can be held up to a certain load. The gas spring can be selected as a compression or a tension spring depending on the intended use thereof; and, due to the flat spring load-deflection characteristic, it is far superior to a metal spring for this range of tasks.

Therefore, the gas spring supports a lift motion of a working cylinder in one direction, in the opposite direction, the working cylinder must operate against the spring; however, the total output of such a working cylinder remains nevertheless positive, because there is no need to incorporate a larger electric motor, a larger transmission and a larger spindle drive. Furthermore, the gas spring can simultaneously serve as a piston rod for the cylinder.

According to the invention, this object is achieved by the characteristics as set forth in the first claim.

The core aspect of the present invention envisions that, in an electric or hydraulic working cylinder or rotary drive, a gas spring supports a lift motion in one direction, that a stroke position can be blocked, if necessary, and, in the event of a system failure, said system is able to take a predetermined stroke position.

Further advantageous embodiments of the invention are set forth in the dependent claims.

### BRIEF DESCRIPTION OF THE DRAWINGS

Based on the drawings, embodiments of the invention shall be illustrated in further detail below. Same elements in different figures are provided with identical reference signs.

Shown are as follows:

FIG. 1 is a schematic side view of an electric working cylinder with the electric motor, the transmission, the spur gear unit and the spindle drive with the gas spring integrated therein and axially supported, as well as an electromechanical stroke locking mechanism with emergency activation;

FIG. 2 is a schematic side view of an electric working cylinder with the electric motor, the transmission, the spur gear unit and the spindle drive with the gas spring integrated therein and axially supported, as well as a blocking valve actuation that is routed to the outside;

FIG. 3 is a schematic side view of a pivotable platform on a parallelogram with a working cylinder or, in the alternative, a hydraulic motor between the structure and a swing arm, as well as and attached parallel thereto a gas spring, or optionally a gas spring that is mounted on the platform and one of the swing arms;

FIG. 4 is a schematic side view of a hydraulic working cylinder with the cylinder of the gas spring as piston rod, a blockable means of the gas spring and a pressure compensation for the blockable gas tension spring.

Only elements that are essential for an immediate understanding of the invention are represented in a schematic fashion.

### WAYS OF EMBODYING THE INVENTION

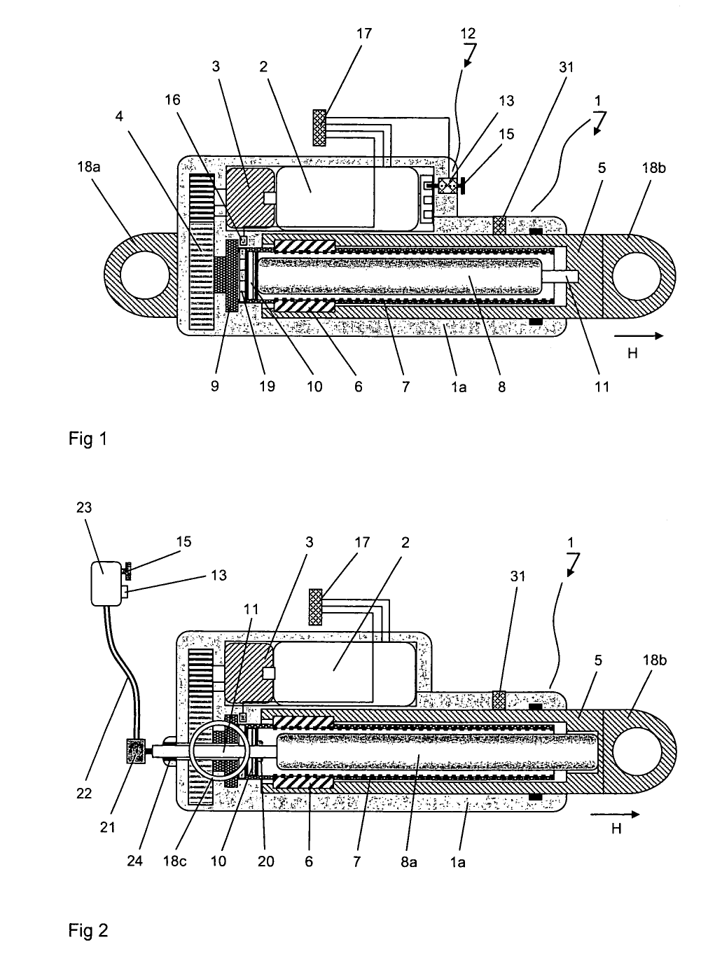

FIG. 1 shows a schematic side view of an electric hybrid working cylinder 1 with the electric motor 2, the transmission 3, the spur gear unit 4 and the piston rod 5 that has a spindle nut 6 mounted thereon and that is powered by the hollow spindle 7, inside which there is located the gas spring 8 that rests, on the one hand, on the floor bearing 9 supported by means of an axial bearing 10 and presses, on the other hand, by way of the gas spring piston rod 11 against piston rod 5 and is incorporated in housing 1a. An electromechanical stroke locking mechanism 12 is present on the electric motor 2 that is made up of a lifting magnet 13 that engages in a locking disc 14, and the lifting magnet 13 includes an emergency trigger 15. Stroke H is monitored by means of a lifting sensor 16 and forwards data to the controller 17, which also controls the opening and closing operation of the lifting magnet 13. The hybrid working cylinder is fastened on the corresponding system at the two mounting eyes 18a,18b.

The electric hybrid working cylinder 1 is constructed in the same way as any normal electric working cylinder; it has a shortened housing 1a therein due to the motor 2 and the transmission 3 being located in an axis-parallel position relative to the spindle drive, which is placed in a second plane by means of the spur gear unit drive 4, and the guided piston rod 5 as well as the spindle nut 6 are located in said plane, and it has a spindle that includes a hollow bore and is correspondingly supported as hollow spindle 7, and thrust as well as tension forces are absorbed by the floor bearing 9. The gas spring 8 is incorporated in the hollow spindle 7 and supported, on the one hand, on the floor bearing 9, which has a separate axial bearing 10, and the gas spring 8 supports itself on the opposite side on the piston rod 5. Gas spring 8 does not rotate around the axis thereof in this configuration; however, conceivably, the same would be able to rotate as well for which purpose the axial bearing 10 would have to be mounted between the gas spring piston rod 11 and the piston rod 5. Furthermore, the embodied example shows the gas spring 8 in the pressure configuration, meaning the hybrid working cylinder 1 is supported in the direction of push-out according to arrow H. In the opposite direction, the hybrid working cylinder 1 must generate a force in order to compress the gas spring 8.

If a weight of 1000 N is to be lifted, in theory meaning without subtraction of additional frictional forces, a working cylinder 1 having a thrust force of 500 N is needed, with the remaining 500 N being generated by means of the gas spring 8. When swinging back, for example without load, the hybrid working cylinder 1 must work against the push-out force of the gas spring 8, also 500 N. Despite this double load for the electric motor 2, the energy balance is nevertheless positive because a correspondingly sized electric motor 2 is needed for lifting but is completely oversized for the lowering operation turning in an output range of poor efficiency, while still performing work either to overcome the self-locking action of the hollow spindle 7 or as a brake in the context of a recirculating ball spindle solution. Electric motor 2 having half the power can be configured precisely for the optimum output curve thereof operating identically in both directions. Furthermore, mass and sizing of a transmission must not be underestimated, which, with the corresponding thrust output, can possibly only be implemented by means of an additional gear reduction step.

If the swing operation also includes safety requirements, the same can be achieved by means of a stroke locking mechanism 12 that is attached to the electric motor 2 in that a locking disc 14 is mounted on the electric motor 2 that can be blocked in the rotation thereof by means of a lifting magnet 13. Each time when the hybrid working cylinder 1 is activated, the controller 17 shall give the command to open the lifting magnet 13, such that it is then possible to freely rotate locking disc 14 meaning the electric motor 2 is no longer blocked. In this case, the lifting magnet 13 includes a pin that acts radially or axially, directly or by means of a bolt, upon the locking disc 14. Also, the locking disc 14 can be a perforated disc, or it can include a ratchet-and-pawl locking mechanism for certain applications, such that the lifting magnet 13 must not be actuated in one direction, in the present example in the counter-direction push-out location H, to move the piston rod 5 but only in the opposite direction. If the hybrid working cylinder 1 fails, the emergency trigger 15 can be actuated that releases the lifting magnet 13 freeing locking disc 14, and whereby gas spring 8 pushes the piston rod 5 forward in the direction of the push-out location H.

Despite hollow spindle 7, stroke H or the number and partial number of rotations of the hollow spindle 7, respectively, can be detected by means of the sensor disc 19 and sensor 16, which is a Hall generator or induction-type pulse generator or the like, and forwarded to the controller 17 to influence, on the one hand, the speed of the electric motor 2 or to correspondingly activate, on the other hand, the lifting magnet 13. It is important, furthermore, that any generation of great pressure fluctuations inside the hybrid working cylinder 1 due to the entry and exit of the piston rod 5 is avoided, or that, with quick temperature changes, the air inside the hybrid working cylinder 1 can also breathe, such that virtually no pressure fluctuations occur. This is achieved by means of an air filter 31, simultaneously hydrophobic and dirt-particle-repelling, and mounted in a bore hole of the housing of the hybrid working cylinder 1. The hybrid working cylinder 1 can, moreover, include a freewheeling mechanism that is presently not shown but nicely harmonizes with the integrated gas spring 8.

FIG. 2 shows a schematic side view of an electric hybrid working cylinder 1 with the electric motor 2, the transmission 3, the spur gear unit 4 and the piston rod 5 with a spindle nut 6 mounted thereto and powered by means of hollow spindle 7 which has located there inside the blockable gas spring 8a that presses, on the one hand, against the inner side of piston rod 5 and is supported, on the other hand, by the gas spring piston rod 11 by means of the axial bearing 10 and snap ring 20 on floor bearing 9, wherein a part of the gas spring piston rod 11 protrudes from the hybrid working cylinder 1 at the end of which blocking valve 21 is mounted and coupled to a trigger 23 by means of a remote cable 22, with the former consisting of a lifting magnet 13 and an emergency trigger 15. The mounting eye 18c is located laterally on the hybrid working cylinder 1.

In terms of the structure thereof, hybrid working cylinder 1 is identical to the configuration as described in FIG. 1 with the difference, however, that the stroke lock operation does not occur on the electric motor 2, instead by means of the blockable gas spring 8a supported, on the one hand, on the inside of the piston rod 5 and pressing, on the other hand, by means of axial bearing 10 and snap ring 20 against the floor bearing 9, wherein a part of the gas spring piston rod 11 is routed in a touchless manner through the floor bearing 9 and spur gear unit 4 and guided, in an exemplary manner, out of the hybrid working cylinder 1 by means of the sealing bearing 24. Blocking valve 21 of the gas spring 8 is located at the end of the gas spring piston rod 11 that is coupled with the trigger 23 by means of the remote cable 22, and inside which a lifting magnet 13 opens and closes blocking valve 21 reacting each time to commands from the controller 17, which simultaneously starts the electric motor 2 or collects current from the same. This way, it is possible to lock or unlock stroke H of the hybrid working cylinder 1 by means of the blockable gas spring 8a. In the event of a total electrical failure, however, it is possible to open blocking valve 21 manually by means of the emergency actuation 15 located on trigger 23, whereby the blockable gas spring 8a presses the piston rod 5 forward according to arrow H, provided the spindle is not a self-locking spindle. In this configuration as well, it is possible for the lifting sensor 16 to be mounted directly on the hollow spindle 7, which provides the advantage that the manufacturing tolerances in the spur gear unit 4, transmission 3 and the connecting elements to electric motor 2 or hollow spindle 7, respectively, cannot negatively impact any of the measurements.

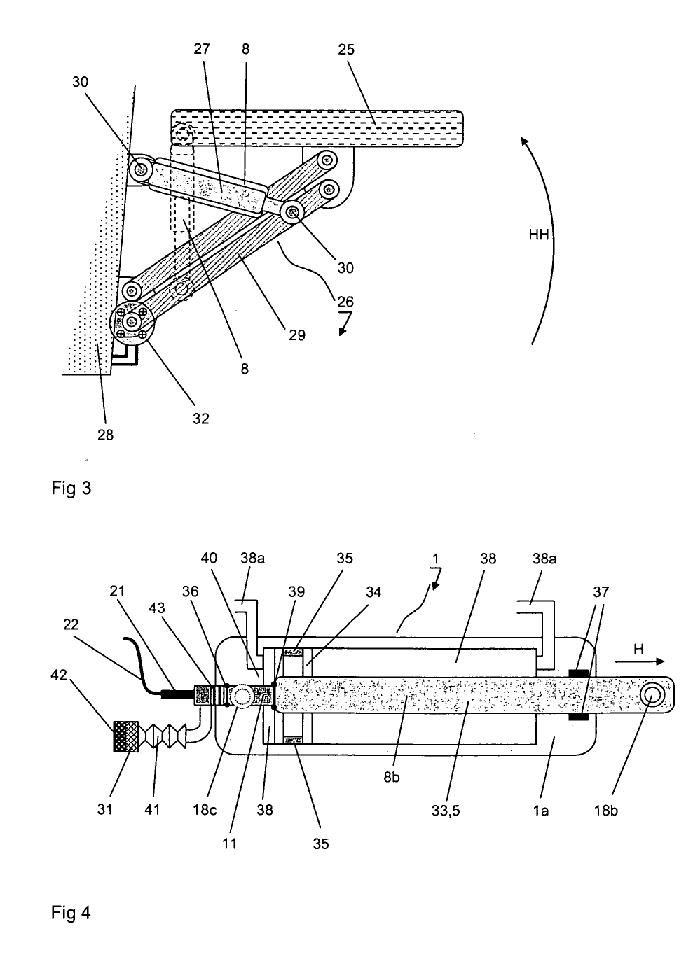

FIG. 3 shows a schematic side view of a pivotable platform 25 on a parallelogram 26 with a fluid working cylinder 27 and, in the alternative, a hydraulic motor 32 between structure 28 and swing arm 29, with a gas spring 8 mounted on the same axes 30 parallel thereto.

In particular when lifting items by means of a parallelogram 26 on a platform 25, the hybrid working cylinder 1 proves to be especially advantageous; however, when using hydraulic systems, it makes less sense except for use as an emergency adjuster. The gas spring 8 herein can be mounted cheaply, parallel relative to the fluid operating cylinder 27 by means of extended axes 30, such that a great level of safety is incorporated involving little complexity, for example on elevating tailgates on trucks; and in case of a hydraulic leak or a pump failure, after the hydraulic system has been switched pressureless, the platform 25 is automatically raised according to arrow HH and the system can be closed with the truck driver himself being able to drive to the next repair location. To this end, a blockable gas spring 8 can always be in the opened state, and it is only blocked in an emergency situation, after the platform 25 has reached the homing position.

Conceivably, the gas spring 8 can be placed on lifting platforms of watercraft between platform 25 and structure 28, or the body of the watercraft, respectively; and instead of a working cylinder, a turning means can be mounted therein, for example a hydraulic motor (32) that benefits in the same way from the emergency running function of the gas spring.

FIG. 4 shows a schematic side view of a hybrid working cylinder 1 in form of a hydraulic working cylinder with integrated blockable gas tension spring 8b that serves simultaneously as piston rod 5, and also includes a connection to the blocking valve 21 and the remote cable 22 as well as a the bellows 35 or the air filter 31 and a moisture inhibitor in form of a silicate means 36.

Instead of mounting the gas spring 8 separately or parallel relative to a working cylinder, presently demonstrated is a way to integrate the gas spring 8—represented herein as blockable gas tension spring 8b—directly in the hybrid working cylinder 1 as a cost-reduction and space-saving measure, specifically in that the gas spring cylinder 33 serves simultaneously as a piston rod, and the piston 34 is mounted on the gas spring cylinder 33 by the piston seal 35. The floor of the gas spring cylinder 33 becomes the outer-located end of the piston rod to which the mounting eye 18b is attached, and the gas spring piston rod 11 is simultaneously fixedly connected to housing 1a, for example by means of a screwed connection 43, and sealed toward the outside, in an exemplary manner by means of a sealing means 36, and on the opposite side by means of the piston rod seal 37. It is possible that the seal of the gas spring is not optimally compatible with the hydraulic oil 38 that is correspondingly introduced by means of feed lines 38a into housing 1a, wherefore a rod seal 39 is additionally mounted on the gas spring piston rod 11 for extra security. The inside of the blockable gas tension spring 8b, or of the blockable gas spring 8a, is known in the prior art. Presently shown is the somewhat more complex solution of a blockable gas tension spring 8b, which is at the end of gas spring piston rod 11, which protrudes somewhat from the cylinder floor 40 and is connected thereto, and where there is located the connection for the blocking valve 21 that confirms an insofar known blocking valve in the gas spring piston rod 11, which is not shown.

For constructional reasons, a blockable gas tension spring 8b requires an opening in the gas spring piston rod 11 to ensure the air exchange. This is associated with the risk that dirt can be sucked in during the extension action of the gas spring piston rod 11 or the gas spring cylinder 33 as piston rod, respectively, which is why a hydrophobic air filter 31 is mounted over the opening. A bellow 41 is installed if the gas spring piston rod 11 comes in contact with a great deal of water; and the bellows allows for an air exchange or only a minimal pressure increase, respectively, and constitutes an enclosed space. A replaceable silicate means 42, for example in form of a pill, ensures good dehumidifying properties under any conditions. The bellows 41 has the added advantage that, despite the enclosed space, the pressure inside the hollow space of the gas spring piston rod 11 remains virtually unchanged when temperature fluctuations occur. For special sizes and small batches of such hydraulic hybrid working cylinders 1, the use of a simple hollow piston rod 5 can possibly be more cost-efficient while using, inside the hollow space, a standard gas spring 8 that is inserted between the cylinder floor 40 and the bore hole end of the hollow piston rod 5, or a gas tension spring 8a that is located similarly there-between but is connected, as described above, to the cylinder floor 40 by means of the screwed connection 43 or another connection type, and connected in a tension-proof manner to the gas spring cylinder 33 by the hollow piston rod 5.

It is understood that the invention is not limited to the demonstrated and described embodiments.

### LIST OF REFERENCE SIGNS

1 Hybrid working cylinder
1a Housing
2 Electric motor
3 Transmission
4 Spur gear unit
5 Piston rod
6 Spindle nut
7 Hollow spindle
8 Gas spring
8a Blockable gas spring
8b Blockable gas tension spring
9 Floor bearing
10 Axial bearing
11 Gas spring piston rod
12 Stroke locking mechanism
13 Lifting magnet
14 Locking disc
15 Emergency actuation
16 Lifting sensor
17 Controller
18a, 18b, 18c Mounting eye
19 Sensor disc
20 Snap ring
21 Blocking valve
22 Remote cable
23 Trigger
24 Seal bearing
25 Platform
26 Parallelogram
27 Fluid working cylinder
28 Structure
29 Swing arm
30 Axis
31 Air filter
32 Hydraulic motor
33 Gas spring cylinder
34 Piston
35 Piston seal
36 Sealing means
37 Piston rod seal
38 Hydraulic oil
38a Feed lines
39 Rod seal
40 Cylinder floor
41 Bellows
42 Silicate means
43 Screwed connection
H Stroke piston rod 5
HH Stroke platform 25

1. A hybrid working cylinder, wherein
the hybrid working cylinder includes a hollow spindle and a hollow-bore piston rod with an integrated gas spring therein that is supported on the inner part of the piston rod and the floor bearing, or that the gas spring cylinder serves as piston rod and acts upon the cylinder floor.

2. The hybrid working cylinder (1) according to claim 1, wherein
an axial bearing is located on the gas spring, and the gas spring rotates together with the hollow spindle or is inactive together with the same.

3. The hybrid working cylinder according to claim 1, wherein
a piston with piston seal is mounted on the gas spring cylinder.

4. The hybrid working cylinder according to claim 1, wherein
the stroke locking mechanism is made up of a lifting magnet and a blocking disc, and the blocking disc includes a toothing or a perforated mask, as well as an emergency actuation or/and a remote cable.

5. The hybrid working cylinder (1) according to claim 1, wherein
the gas spring includes a blocking valve and can be actuated by means of a lifting magnet on the hybrid working cylinder (1) directly or via remote cable, and includes an emergency actuation.

6. The hybrid working cylinder according to claim 1, wherein
the lifting magnet actuates the stroke locking mechanism or the locking valve and works together with the power from the electric motor or/and on command by the controller in that the power switching for the electric motor does not occur simultaneously with the opening and closing action of the stroke locking mechanism or the blocking valve.

7. The hybrid working cylinder according to claim 1, wherein
by manual triggering of the emergency actuation, the same deactivates the lifting magnet, and the magnet valves are manually opened on the hydraulic or pneumatic working cylinder in order to generate a stroke in the event of an emergency.

8. The hybrid working cylinder according to claim 1, wherein
the air filter or the bellows on the inside of the hybrid working cylinder generates a pressure equalization relative to the outside environment of the hybrid working cylinder during movement of the piston rod or with fast temperature drops, or/and a silicate means is incorporated.

9. The hybrid working cylinder according to claim 1, wherein
the hybrid operating cylinder is an electrical or a hydraulic or a pneumatic working cylinder or a rotatable working means.

10. The hybrid working cylinder (1) according to claim 1, wherein
the gas spring supports the hybrid working cylinder in one direction by way of providing force, and in that, in the opposite direction, the hybrid working cylinder operates against the gas spring, and the gas spring brings the piston rod by means of the emergency actuation in the predefined end stop position.

11. The hybrid working cylinder according to claim 1, wherein
a gas spring is mounted parallel relative to an electric or hydraulic or pneumatic working means by means of extended axes.

12. The hybrid working cylinder according to claim 1, wherein
a gas spring is mounted between the structure or the plate and the swing arm and acts as a pressure or tension spring.

13. The hybrid working cylinder according to claim 1, wherein
the hybrid working cylinder includes a stroke locking mechanism or a blocking valve.

14. The hybrid working cylinder according to claim 1, wherein
mounted on the hollow spindle is a lifting sensor, and the same is connected to a controller.

15. The hybrid working cylinder according to claim 1, wherein
the gas spring acts in response to pressure or tension and is blockable.
